(19) United States
(12) Patent Application Publication
(10) Pub. No.: US 2025/0193664 A1
(43) Pub. Date: Jun. 12, 2025

(54) ACCESS POINT OR ROUTER-BASED ROTATION AND EXCHANGE OF DATA ENCRYPTION/DECRYPTION KEYS

(71) Applicant: CenturyLink Intellectual Property LLC, Denver, CO (US)

(72) Inventors: John R.B. Woodworth, Amissville, VA (US); Dean Ballew, Sterling, VA (US)

(73) Assignee: CenturyLink Intellectual Property LLC, Denver, CO (US)

(21) Appl. No.: 18/965,272

(22) Filed: Dec. 2, 2024

Related U.S. Application Data
(60) Provisional application No. 63/607,443, filed on Dec. 7, 2023.

(51) Int. Cl. H04W 12/06; H04W 12/041

(52) U.S. Cl. CPC H04W 12/06; H04W 12/041

(57) ABSTRACT

Novel tools and techniques are provided for implementing access point or router-based rotation and exchange of data encryption/decryption keys. After receiving a request for a key and after confirming authentication of the client device, the computing system generates a first key based at least in part on an identifier of the client device, and encrypts the first key using a shared key, which includes a key or key-pair that is shared between the computing system and the client device. The computing system sends the encrypted first key via a connection that is established between the client device and the computing system. The encrypted first key, after being decrypted by the shared key, is usable by the client device either to encrypt first data for sending over an external network via the computing system or to decrypt second data that is received over the external network via the computing system.

### CROSS-REFERENCE TO RELATED APPLICATIONS

This application claims the benefit of U.S. Provisional Application No. 63/607,443 filed Dec. 7, 2023, entitled “Access Point or Router-Based Rotation and Exchange of Data Encryption/Decryption Keys,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing secure exchange of data encryption/decryption keys, and, more particularly, to methods, systems, and apparatuses for implementing access point or router-based rotation and exchange of data encryption/decryption keys.

### BACKGROUND

Transferring sensitive data between wirelessly connected devices requires encryption of such data. However, where one or more such devices may be lost or stolen, encryption keys that are used and stored on these devices may be susceptible to exposure. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing credential management across multiple devices for wireless network access and/or access point or router-based rotation and exchange of data encryption/decryption keys, in accordance with various embodiments.

FIGS. 2A and 2B depict various example systems illustrating various sets of example credential data that are used by a wireless access point device when implementing credential management across multiple devices for wireless network access, in accordance with various embodiments.

FIGS. 3A and 3B depict flow diagrams illustrating an example method for implementing credential management across multiple devices for wireless network access, in accordance with various embodiments.

FIGS. 4A-4E depict flow diagrams illustrating another example method for implementing credential management across multiple devices for wireless network access, in accordance with various embodiments.

FIGS. 5A and 5B depict various example systems illustrating various sets of example key data that are used by a wireless access point device when implementing access point or router-based rotation and exchange of data encryption/decryption keys, in accordance with various embodiments.

FIGS. 6A and 6B depict flow diagrams illustrating an example method for implementing access point or router-based rotation and exchange of data encryption/decryption keys, in accordance with various embodiments.

FIG. 7 depicts a block diagram illustrating an exemplary computer or system hardware architecture, in accordance with various embodiments.

### DETAILED DESCRIPTION OF CERTAIN EMBODIMENTS

### Overview

Various embodiments provide tools and techniques for implementing secure exchange of data encryption/decryption keys, and, more particularly, to methods, systems, and apparatuses for implementing access point or router-based rotation and exchange of data encryption/decryption keys.

In various embodiments, a computing system receives, from a client device, a request for a key. After confirming authentication of the client device, the computing system generates a first key based at least in part on an identifier of the client device, where the first key is a temporary key. The computing system encrypts the first key using a shared key, the shared key including a key or key-pair that is shared between the computing system and the client device. The computing system sends the encrypted first key via a connection that is established between the client device and the computing system. In some cases, the encrypted first key, after being decrypted by the shared key, is usable by the client device either to encrypt first data for sending over an external network via the computing system or to decrypt second data that is received over the external network via the computing system.

In some aspects, a mechanism is provided for encrypting data based upon periodic rotation of encryption keys further based on time and media access control (“MAC”) (or other credentials). An example may include a unique storage key, timecode, and identifier through a dynamic host configuration protocol (“DHCP”) service or other network management service. This key may be used by the device until the next one is provided and maintained by the router (and optionally key-backup-device). Under normal operation, the client device or an Internet of Things (“IoT”) device may request access to keys for different times through an application programming interface (“API”), which is protected through an access management agent. This agent may monitor and reject or deny requests unless authorized by an administrator. In the event of a stolen device, the data housed within the storage of the IoT device will be inaccessible without access to the decryption keys.

These and other aspects of the methods and system for implementing access point or router-based rotation and exchange of data encryption/decryption keys are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by a computing system and from a client device, a request for a key. The method further includes, after confirming authentication of the client device, generating, by the computing system, a first key based at least in part on an identifier of the client device, wherein the first key is a temporary key; and encrypting, by the computing system, the first key using a shared key, the shared key including a key or key-pair that is shared between the computing system and the client device. The method further includes sending, by the computing system, the encrypted first key via a connection that is established between the client device and the computing system. In some cases, the encrypted first key, after being decrypted by the shared key, is usable by the client device either to encrypt first data for sending over an external network via the computing system or to decrypt second data that is received over the external network via the computing system.

In examples, the computing system includes one of a wireless access point device, a router, a server, a gateway device, or other network node, and/or the like. In some instances, the identifier of the client device includes one of a MAC address, a serial number, a combination of model number and device number, or an Internet protocol (“IP”) address, and/or the like. In some cases, the first data and the second data each includes at least one of textual data, numerical data, alphanumerical data, image data, video data, game data, business data, health data, or personal data, and/or the like.

In some examples, confirming authentication of the client device includes authenticating, by the computing system, the client device; and after authenticating the client device, establishing, by the computing system, the connection between the client device and the computing system. In some instances, the computing system includes a wireless access point device, and the method further includes, after authenticating the client device and prior to establishing the connection: generating and associating, by the wireless access point device, a first credential for and with the client device; setting, by the wireless access point device, a first time-to-live (“TTL”) value for the first credential; setting, by the wireless access point device, a second TTL value for the first credential; and sending, by the wireless access point device, the first credential to the client device. In some examples, the first TTL value corresponds to a first time period, during which the first credential is valid, the first time period corresponding to a duration of a first session between the client device and the wireless access point device. In some instances, the second TTL value corresponds to a second time period, during which the first credential is valid, a start of the second time period following termination of the first time period. In some cases, establishing the connection is performed after receiving the first credential from the client device, while one of the first TTL value or the second TTL value is valid.

In examples, the method further includes storing, by the computing system, one of the first key or the encrypted first key in a secure key storage system of a data storage device, in association with or in relation to the client device and/or the identifier of the client device. In some instances, the data storage device is one of a local data storage device, a remote data storage device, or a cloud storage device, and/or the like. In some examples, the method further includes, in response to a determination or an indication that the client device has either lost connection to the computing system or lost power, causing, by the computing system, the first key to be invalidated or to expire.

In some examples, the method further includes, after receiving, from the client device, the first data that has been encrypted using the first key, sending, by the computing system, the encrypted first data to one of the external network or a first network device over the external network, wherein the first key includes one of an encryption key or a symmetric key. Alternatively or additionally, the method further includes, after receiving, from one of the external network or a second network device over the external network, the second data, encrypting, by the computing system, the second data using a second key, and sending, by the computing system, the encrypted second data to the client device, wherein the first key is used to decrypt the encrypted second data, wherein the first key includes one of a decryption key or the symmetric key.

In another aspect, the technology relates to a system, including a computing system, including at least one first processor and a first non-transitory computer readable medium communicatively coupled to the at least one first processor. The first non-transitory computer readable medium has stored thereon computer software including a first set of instructions that, when executed by the at least one first processor, causes the computing system to: receive, from a client device, a request for first data; after confirming authentication of the client device, retrieve the first data from a data source; generate a first key, based at least in part on an identifier of the client device; encrypt the retrieved first data using the first key; and send, to the client device and via a connection that has been established between the client device and the computing system, the encrypted first data in response to the request.

In some examples, the computing system includes one of a wireless access point device, a router, a server, a gateway device, or other network node, and/or the like. In some instances, the data source includes one of a local cache, a local data storage system, a server accessible over a network, a network node accessible over the network, or a cloud storage system, and/or the like. In some cases, the first set of instructions, when executed by the at least one first processor, further causes the computing system to: send, to the client device, at least one of a time code or an identifier code associated with one or more of the first key or a corresponding second key, concurrent or in sequence with sending the encrypted first data, the first key having been used to encrypt the encrypted first data. In some examples, the first key includes one of an encryption key or a symmetric key, wherein the second key includes one of a decryption key corresponding to the encryption key or the symmetric key. Alternatively or additionally, the first set of instructions, when executed by the at least one first processor, further causes the computing system to: in response to receiving, from the client device, a request for a decryption key that either corresponds to the encrypted first data or is capable of decrypting the encrypted first data, encrypt the corresponding second key using a shared key; and send, to the client device and via the established connection, the encrypted second key.

In yet another aspect, the technology relates to a method, including receiving, by a computing system and from a client device, a request for a key; and, after confirming authentication of the client device, generating and associating, by the computing system, a first key based at least in part on an identifier of the client device. In some examples, the first key includes one of an encryption key or a symmetric key, wherein the first key is a temporary key. The method further includes encrypting, by the computing system, the first key using a shared key, the shared key including a key or key-pair that is shared between the computing system and the client device; sending, by the computing system, the encrypted first key via a connection that is established between the client device and the computing system; and after receiving, from the client device, first data that has been encrypted using the first key, sending, by the computing system, the encrypted first data to one of the external network or a first network device over the external network.

In some examples, the identifier of the client device includes one of a MAC address, a serial number, a combination of model number and device number, or an IP address, and/or the like. In some instances, the first data and the second data each includes at least one of textual data, numerical data, alphanumerical data, image data, video data, game data, business data, health data, or personal data, and/or the like. In some cases, the method further includes storing, by the computing system, one of the first key or the encrypted first key in a secure key storage system of a data storage device, in association with or in relation to the client device and/or the identifier of the client device. In some instances, the data storage device is one of a local data storage device, a remote data storage device, or a cloud storage device, and/or the like. In examples, the method further includes, in response to a determination or an indication that the client device has either lost connection to the computing system or lost power, causing, by the computing system, the first key to be invalidated or to expire.

Various modifications and additions can be made to the embodiments discussed without departing from the scope of the invention. For example, while the embodiments described above refer to particular features, the scope of this invention also includes embodiments having different combination of features and embodiments that do not include all of the above-described features.

### Specific Exemplary Embodiments

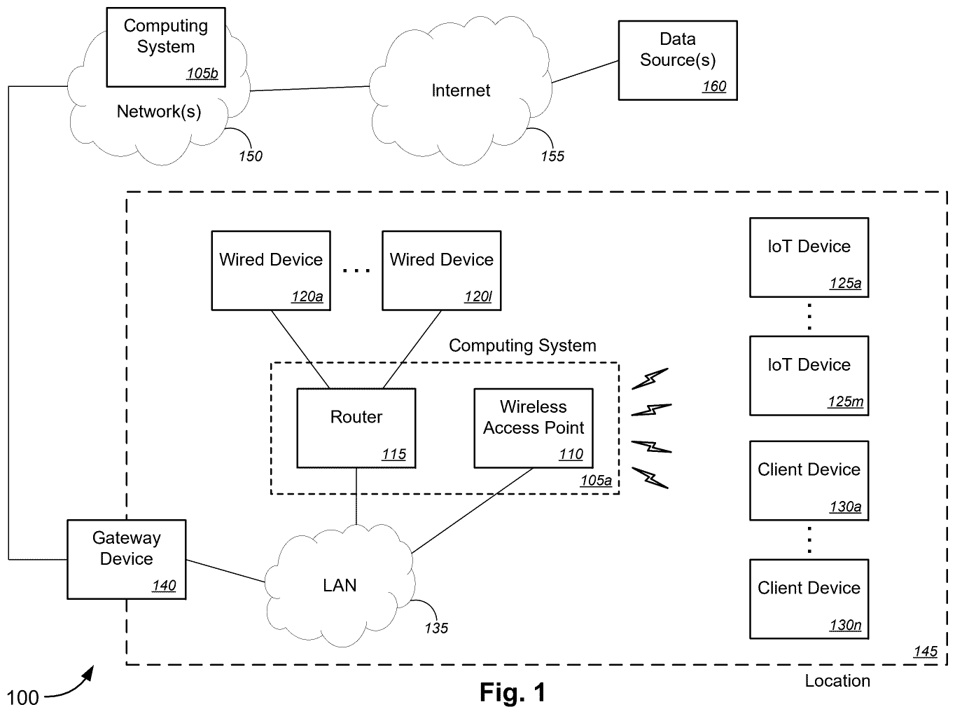

FIGS. 1-7 illustrate some of the features of the method, system, and apparatus for implementing secure exchange of data encryption/decryption keys, and, more particularly, to methods, systems, and apparatuses for implementing access point or router-based rotation and exchange of data encryption/decryption keys, as referred to above. The methods, systems, and apparatuses illustrated by FIGS. 1-7 refer to examples of different embodiments that include various components and operations, which can be considered alternatives or which can be used in conjunction with one another in the various embodiments. The description of the illustrated methods, systems, and apparatuses shown in FIGS. 1-7 is provided for purposes of illustration and should not be considered to limit the scope of the different embodiments.

With reference to the figures, FIG. 1 depicts an example system 100 for implementing credential management across multiple devices for wireless network access and/or access point or router-based rotation and exchange of data encryption/decryption keys, in accordance with various embodiments.

In the non-limiting embodiment of FIG. 1, example system 100 includes a computing system 105a, which includes a wireless access point device 110 and a router 115. System 100 further includes zero or more wired devices 120a-120l (collectively, “wired devices 120” or the like), zero or more IoT devices 125a-125m (collectively, “IoT devices 125” or the like), one or more client devices 130a-130n (collectively, “client devices 130” or the like), a local area network (“LAN”) 135, and a gateway device 140. Herein, l, m, and n are non-negative integer numbers that may be either all the same as each other, all different from each other, or some combination of same and different (e.g., one set of two or more having the same values with the others having different values, a plurality of sets of two or more having the same value with the others having different values, etc.). In some examples, the router 115 may be part of the wireless access point device 110. In examples, the computing system 105a, the wireless access point device 110, the router 115, the zero or more wired devices 120, the zero or more IoT devices 125, the one or more client devices 130, the LAN 135, and the gateway device 140 may be disposed at location 145. In some examples, location 145 includes customer premises including, but not limited to, one of a residential customer premises, a business customer premises, a corporate customer premises, an enterprise customer premises, an education facility customer premises, a medical facility customer premises, or a governmental customer premises, and/or the like. System 100 further includes network(s) 150 and Internet 155. Gateway device 140 couples wireless access point device 110 (and any wirelessly connected devices 125 and 130) and router 115 (and any wired devices 120 connected thereto) via LAN 135, and couples LAN 135 (and devices connected thereto) with Internet 155 via network(s) 150. System 100 further includes computing system 105b disposed in network(s) 150 and one or more data sources 160 accessible via Internet 155 and network(s) 150.

In examples, each client device 130 includes one of a user device, an IoT device (e.g., IoT device 125), or an appliance, or the like. In some cases, the user device includes one of a desktop computer, a laptop computer, a tablet computer, a smart phone, or a portable gaming device, or the like. In some instances, the IoT device 125 each includes one of a wireless network-capable sensor device, a wireless network-capable lighting device, a wireless network-capable appliance, or a drone, or the like. In some cases, the wireless network-capable sensor device includes at least one of a temperature sensor, a humidity sensor, a light sensor, a motion sensor, an infrared sensor, a camera, or a microphone, or the like. In some instances, the wireless network-capable lighting device includes one of a light bulb, a lamp, or a lighting fixture, or the like. In some examples, the appliance or wireless network-capable appliance includes one of a wireless network-capable home office device, a wireless network-capable kitchen appliance, a wireless network-capable entertainment system, a wireless network-capable security system, or a wireless network-capable home appliance, or the like. In some cases, the drone may include an aerial drone, a land-based drone, an aquatic drone, or an amphibious drone, or the like.

In some cases, the wireless network-capable home office device includes one of a printer, a scanner, a projector, a copier, etc., each configured for wireless network connectivity and wireless communication or data transfer. In some instances, the wireless network-capable kitchen appliance includes one of a refrigerator, a dish washer, an oven, a kitchen range, a microwave, a rice cooker, a pressure cooker, an air fryer, a sous vide machine, etc., each configured for wireless network connectivity and wireless communication or data transfer. In some examples, the wireless network-capable entertainment system includes one of a television, a video recording device, a video playback device, a gaming console, a content streaming device, a sound system, etc., each configured for wireless network connectivity and wireless communication or data transfer. In examples, the wireless network-capable security system includes one of one or more cameras, one or more motion detectors, one or more doorway locks, a security interface device, etc., each configured for wireless network connectivity and wireless communication or data transfer. In some embodiments, the wireless network-capable home appliance includes one of a washing machine, a clothes dryer, a wash tower, a garage door opener, a motorized doorway, a motorized window, a motorized window covering, a lighting system, etc., each configured for wireless network connectivity and wireless communication or data transfer.

In some embodiments, one or more client devices—such as a device(s) associated with a user that owns, or is otherwise associated with, location 145—each serves as an administrator device including an administrator user device including one of a desktop computer, a laptop computer, a tablet computer, or a smart phone, or the like. One or more wireless devices (e.g., IoT device(s) 125 and/or client device(s) 130), although primarily connected wirelessly to LAN 135 via wireless access point device 110 (as depicted, e.g., in FIG. 1 by lightning bolt symbols), may alternatively be connected to LAN 135 (as wired device(s) 120) via router 115. Gateway device 140 includes at least one of a modem, a network interface device, or an optical network terminal, and/or the like.

According to some embodiments, network(s) 150 may each include, without limitation, one of a LAN, including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 150 may include an access network of the service provider (e.g., an Internet service provider (“ISP”)). In another embodiment, the network(s) 150 may include a core network of the service provider and/or the Internet.

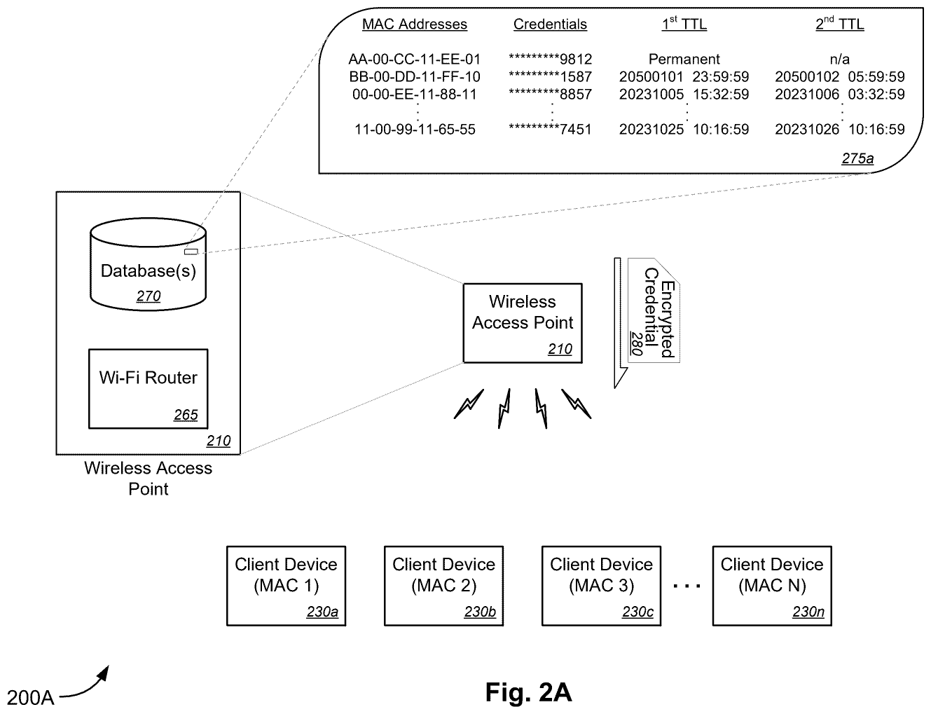

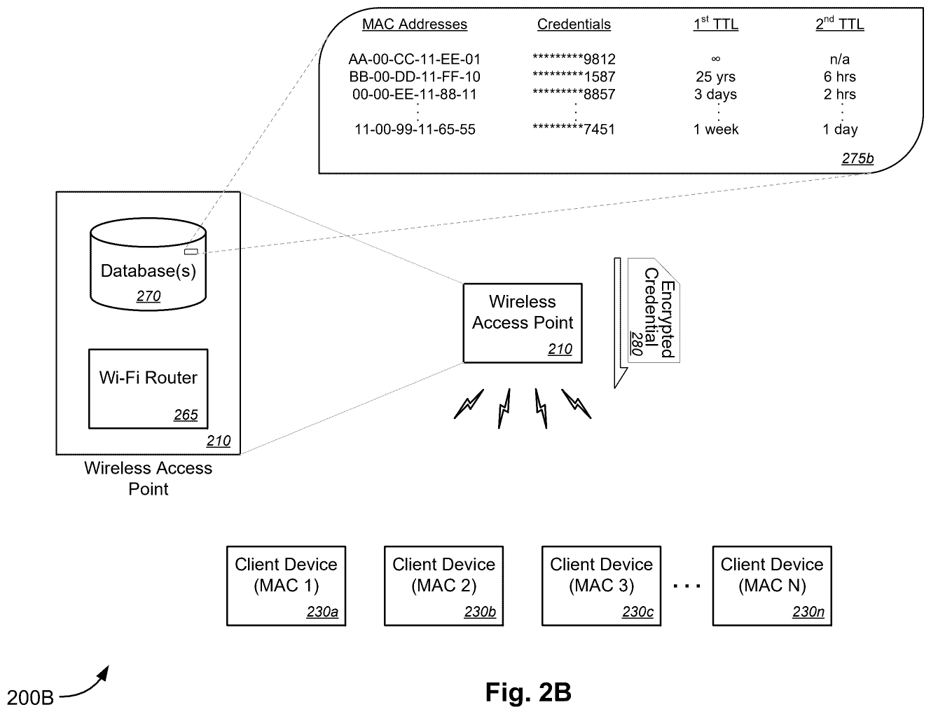

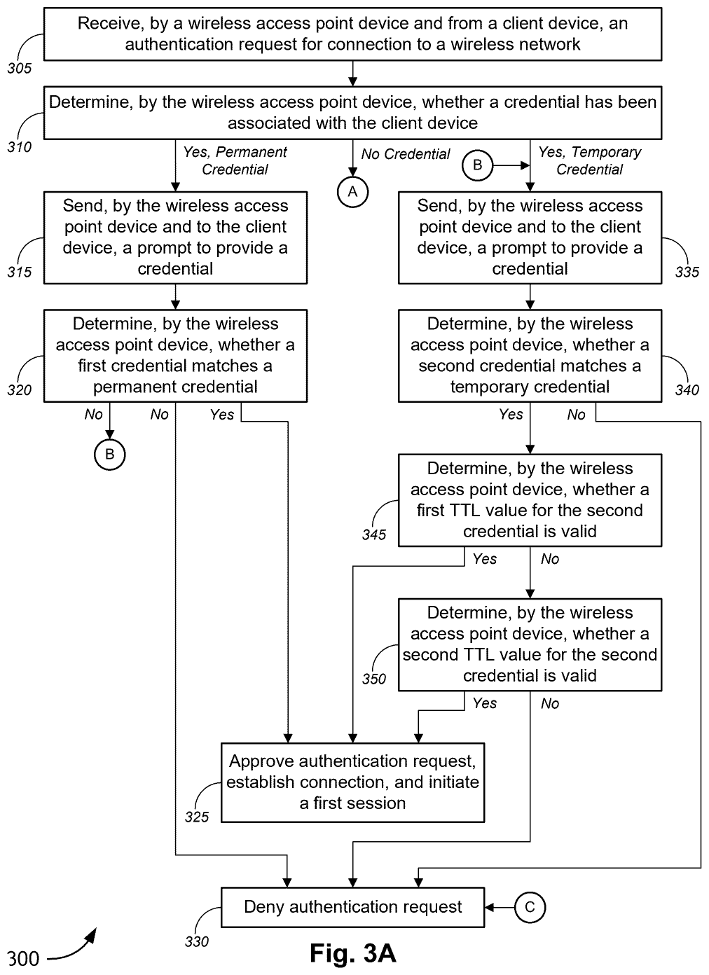

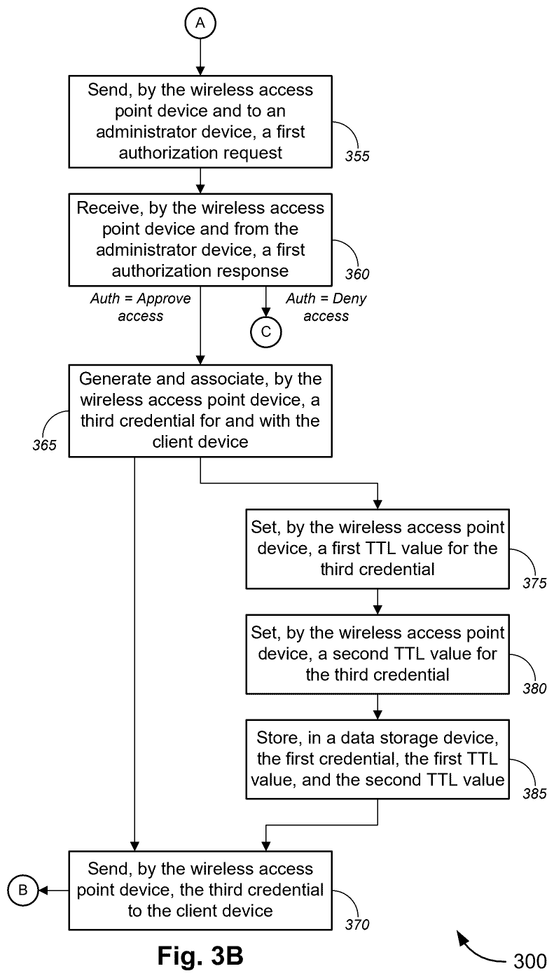

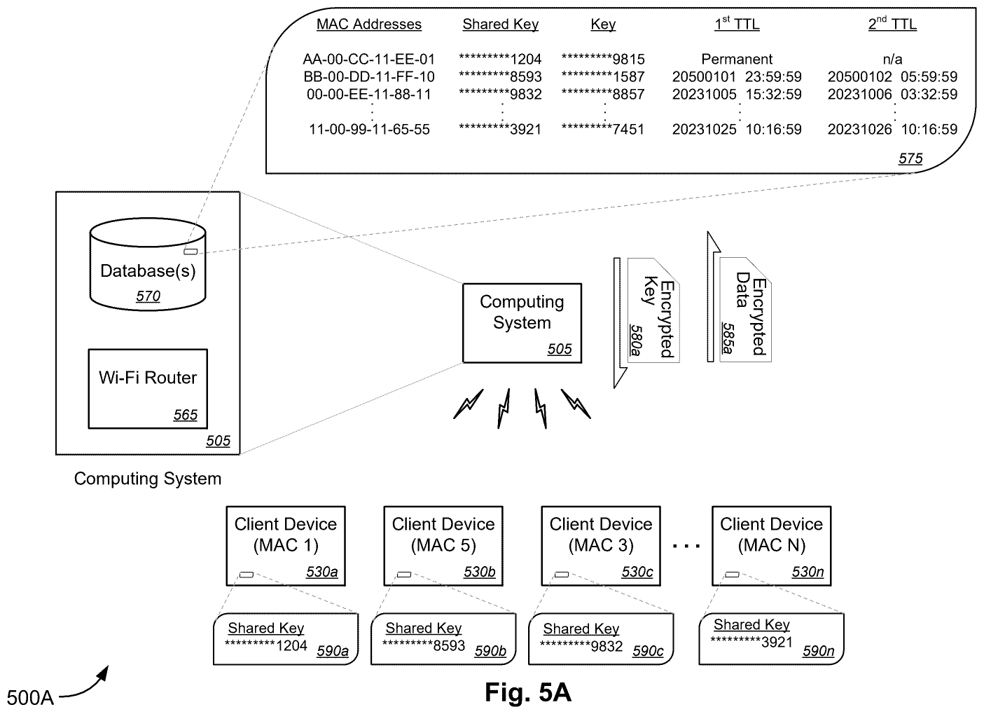

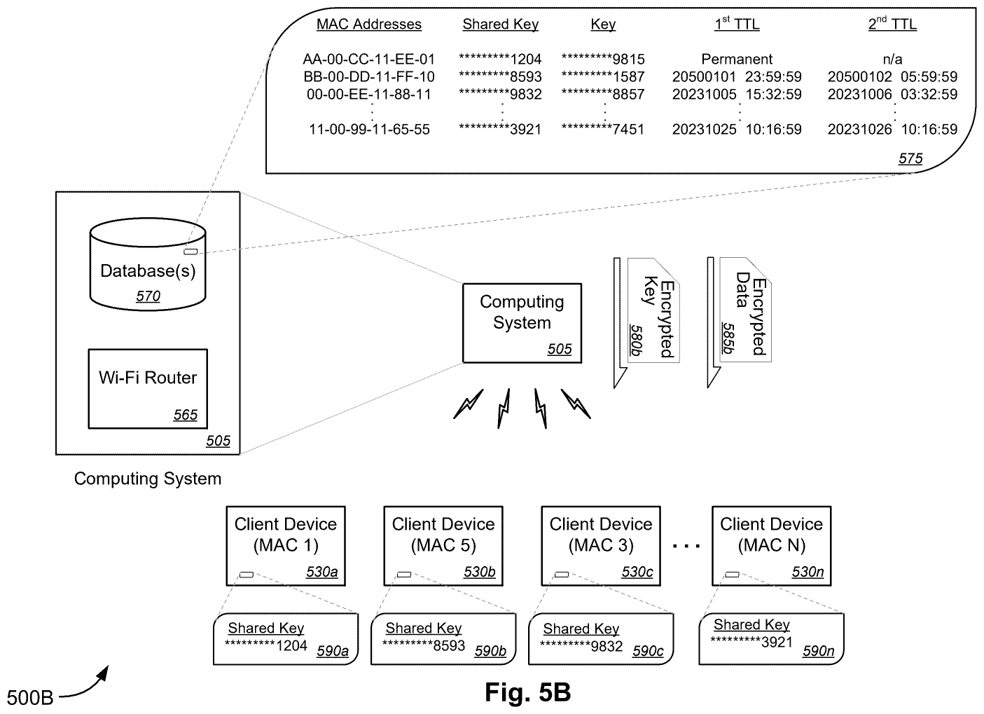

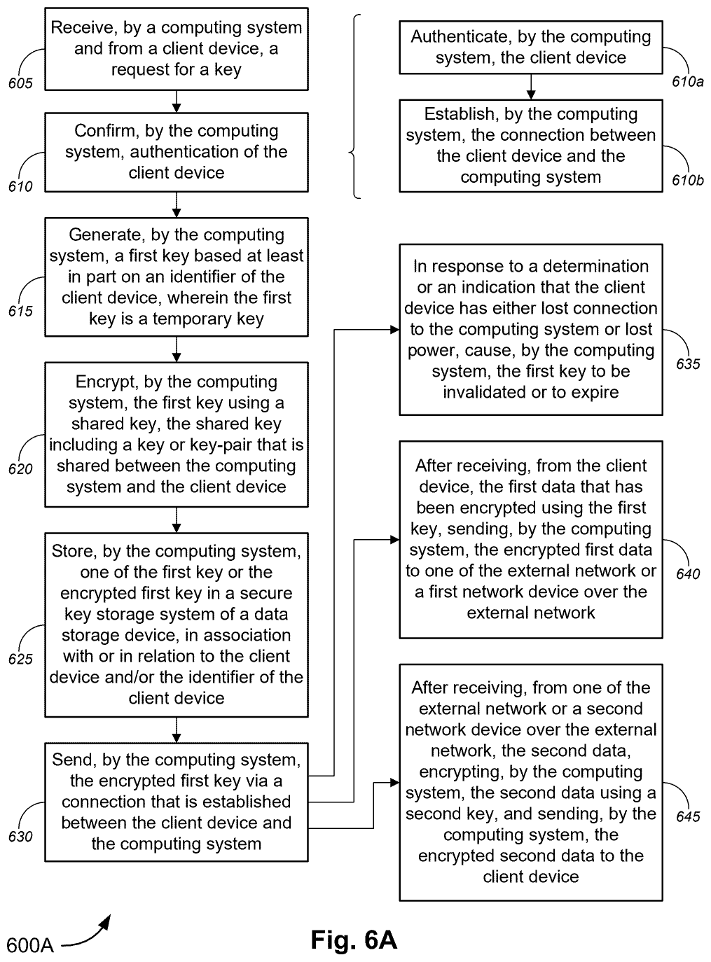

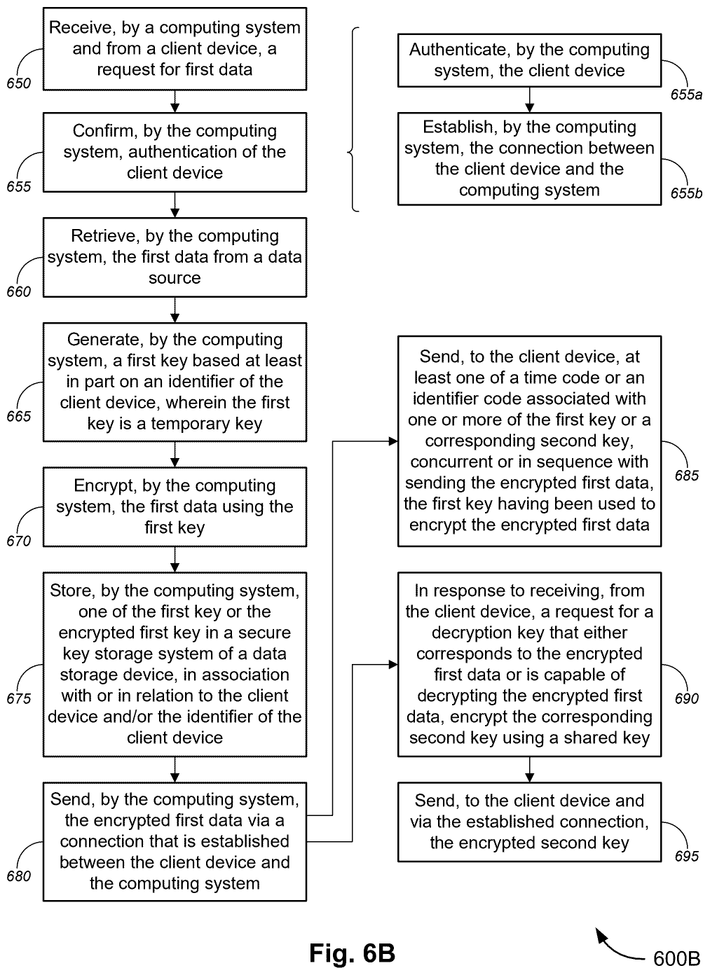

In operation, computing system 105a, computing system 105b, wireless access point device 110, and/or router 115 may perform methods for implementing credential management across multiple devices for wireless network access, as described in detail with respect to FIGS. 2A-4E, and/or performing methods for implementing access point or router-based rotation and exchange of data encryption/decryption keys, as described in detail with respect to FIGS. 5A-6B. For example, the sets of example credential data 275a and 275b as shown with respect to FIGS. 2A and 2B, the sets of example credential data 575a and 575b as shown with respect to FIGS. 5A and 5B, and example methods 300, 400, 600A, and 600B, as shown with respect to FIGS. 3A-3B, 4A-4E, 600A, and 600B, respectively, may be applied with respect to the operations of example system 100 of FIG. 1.

FIGS. 2A and 2B (collectively, “FIG. 2”) depict various example systems 200A and 200B illustrating various sets of example credential data that are used by a wireless access point device when implementing credential management across multiple devices for wireless network access, in accordance with various embodiments. In some embodiments, wireless access point device 210 and client devices 230a-230n of FIG. 2 may be similar, if not identical, to the wireless access point device 110 and client devices 130a-130n (and/or IoT device 125a-125m), respectively, of system 100 of FIG. 1, and the description of these components of system 100 of FIG. 1 are similarly applicable to the corresponding components of FIG. 2.

In FIG. 2, wireless access point device 210 communicatively couples with at least one of one or more client devices 230a-230n (collectively, “client devices 230”), at least for purposes of allowing each client device 230 to request access to a wireless network (e.g., LAN 135 of FIG. 1, or the like). Once a client device 230 has been authenticated and approved for connection to the wireless network, the wireless access point device 210 provides a connection path(s) between the client device 230 and the wireless network. Wireless access point device 210 includes Wi-Fi router 265 and database(s) 270. Each client device 230 has a MAC address associated with it. For each client device 230 that has been provided with access to the wireless network, credentials for accessing the wireless network (whether provided by a user associated with the client device 230, generated by the client device 230, or generated by the wireless access point device 210) may be stored on database(s) 270 associated with corresponding MAC address. Where one or more time-to-live (“TTL”) values are set for a particular credential, these values may also be stored on the database(s) 270 associated with the corresponding MAC address and corresponding credential(s). In some examples, the TTL values may include a first TTL value and a second TTL value. In examples, the first TTL value corresponds to a first time period, during which the corresponding credential is valid, the first time period corresponding to a duration of a first session between the client device 230 and the wireless access point device 210. In such examples, the second TTL value corresponds to a second time period, during which the corresponding credential is valid, a start of the second time period following termination of the first time period. In some examples, the credentials may each include one of a permanent password or a temporary password.

As shown in the non-limiting example 200A of FIG. 2A, credential data 275a may include credentials, first TTL values, and second TTL values associated with corresponding MAC address that is associated with a client device among the one or more client devices 230a-230n. The first TTL values are listed as one of a permanent value for the first time period, an expiration date and time value(s) for the first time period that is years in the future, an expiration date and time value(s) for the first time period that has expired, or an expiration date and time value(s) for the first time period that is one or more minutes, one or more hours, one or more days, one or more weeks, or one or more months in the future, or the like. The second TTL values are listed as one of blank or not applicable, or an expiration date and time value(s) for the second time period (after the expiry of the first time period) that is minutes, hours, days, or weeks, or the like. In examples, the credentials corresponding to a client device 230 or its corresponding MAC address may be encrypted and the encrypted credential 280 may be sent from the wireless access point 210 to the corresponding client device 230, the credential 280 being subject to its corresponding TTL values.

Alternatively, as shown in the non-limiting example 200B of FIG. 2B, credential data 275b may include credentials, first TTL values, and second TTL values associated with corresponding MAC address that is associated with a client device among the one or more client devices 230a-230n. The first TTL values are listed as one of an infinite or unlimited period for validity of the first time period, a time period value for validity of the first time period that is listed in years, or a time period value for validity of the first time period that is listed in minutes, one or more hours, one or more days, one or more weeks, or one or more months, or the like. The second TTL values are listed as one of blank or not applicable, or a time period value for validity of the first time period that is listed in years, or a time period value for validity of the first time period that is listed in minutes, hours, days, or weeks, or the like. Although MAC addresses are used as identifiers associated with the client devices 230, other identifiers may also be used, each identifier including, but not limited to, one of a serial number of the client device, a combination of a model number and a device number associated with the client device, an Internet protocol (“IP”) address that is unique and associated with the client device, or the like.

In some aspects, wireless access point device 210 receives, from a client device among the one or more client devices 230a-230n, an authentication request for connection to a wireless network. The wireless access point device 210 determines whether a credential has been associated with the client device. Based on a determination that a temporary credential has been associated with the client device, the wireless access point device 210 sends, to the client device, a prompt to provide a credential. In response to receiving a first credential from the client device, the wireless access point device 210 performs first tasks. The first tasks include determining whether the first credential is valid. The first tasks further include, based on a determination that the first credential is valid, determining whether a first TTL value for the first credential is valid. In some examples, the valid first credential is unique to and associated with an identifier (e.g., a unique MAC address, a (unique) serial number, a (unique) combination of model number and device number, or a unique IP address, etc.) of the client device. The first tasks further include, when the first TTL value for the first credential is valid, approving the authentication request for the client device, establishing a connection between the client device and the wireless network via the wireless access point device, and initiating a first session between the client device and the wireless network. The first tasks further include, when the first TTL value for the first credential is no longer valid, determining whether a second TTL value is valid. The first tasks further include, when the second TTL value for the first credential is valid, approving the authentication request for the client device, re-establishing the connection between the client device and the wireless network via the wireless access point device, and initiating a second session between the client device and the wireless network.

In some embodiments, the first tasks further include, while the first session is active and prior to expiration of the first time period corresponding to the first TTL value, sending, to an administrator device, a first authorization request. In examples, the administrator device includes a client device among the one or more client devices 230a-230n, such as client device 230a having a MAC address (e.g., MAC 1=“AA-00-CC-11-EE-01” as shown in FIG. 2) associated a credential (e.g., “*********9812” as shown in FIG. 2) that has a permanent first TTL value (e.g., “Permanent” as shown in FIG. 2A or “∞” as shown in FIG. 2B), or client device 230b having a MAC address (e.g., MAC 2=“BB-00-DD-11-FF-10” as shown in FIG. 2) associated a credential (e.g., “*********1587” as shown in FIG. 2) that has a long duration first TTL value (e.g., “20500101 23:59:59” as shown in FIG. 2A or “25 yrs” as shown in FIG. 2B), or the like. The first tasks further include receiving, from the administrator device, a first authorization response indicating whether to extend the first time period while the first session is continuing, by changing the first TTL value. The first tasks further include, when the first authorization response indicates that the first time period should not be extended, causing the first session to be terminated upon expiration of the first time period corresponding to the first TTL value. Alternatively, the first tasks further include, when the first authorization response indicates that the first time period should be extended, modifying the first TTL value based on the first authorization response to extend the first time period.

According to some embodiments, based on a determination that a credential has not been associated with the client device, the wireless access point device 210 sends, to the client device, a prompt to request a new credential; and, in response to receiving a request for a new credential, performs second tasks. In some examples, the second tasks further include sending, to the administrator device, a second authorization request for establishing a connection between the client device and the wireless network; and receiving, from the administrator device, a second authorization response to the second authorization request; and, based on the second authorization response indicating to provide access to the client device, performing third tasks. The third tasks include generating and associating a second credential for and with the client device; setting a first TTL value for the second credential; setting a second TTL value for the second credential; and sending the second credential to the client device.

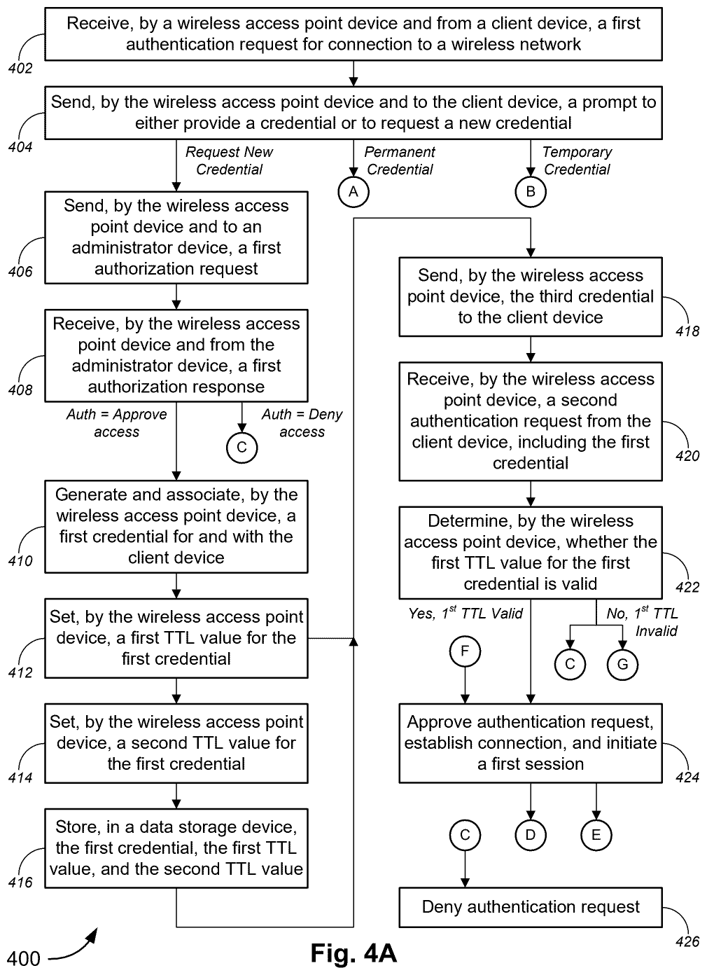

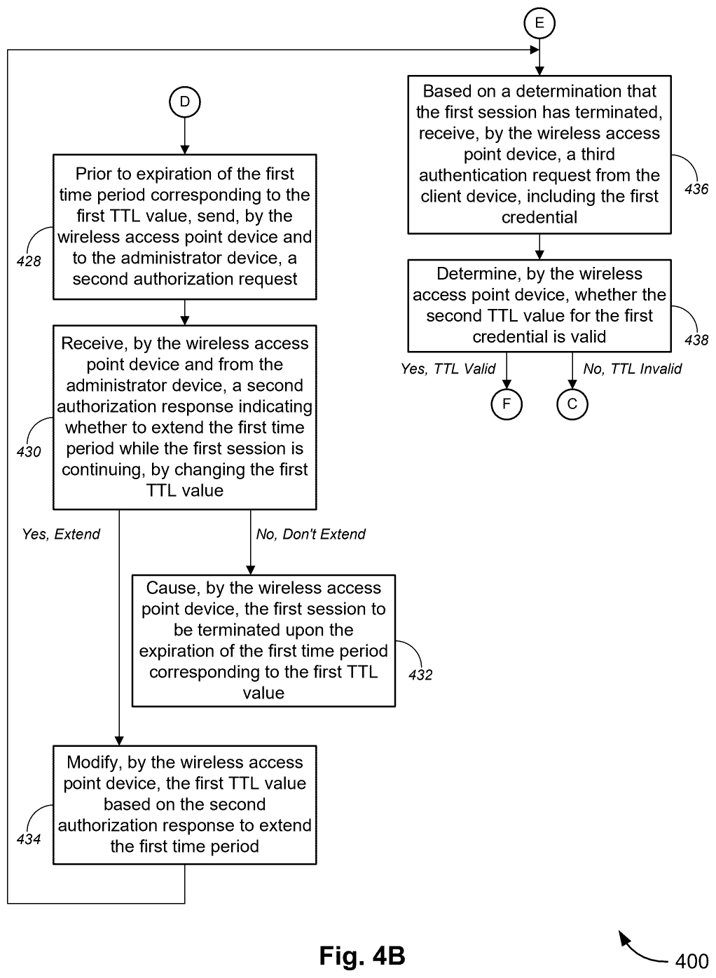

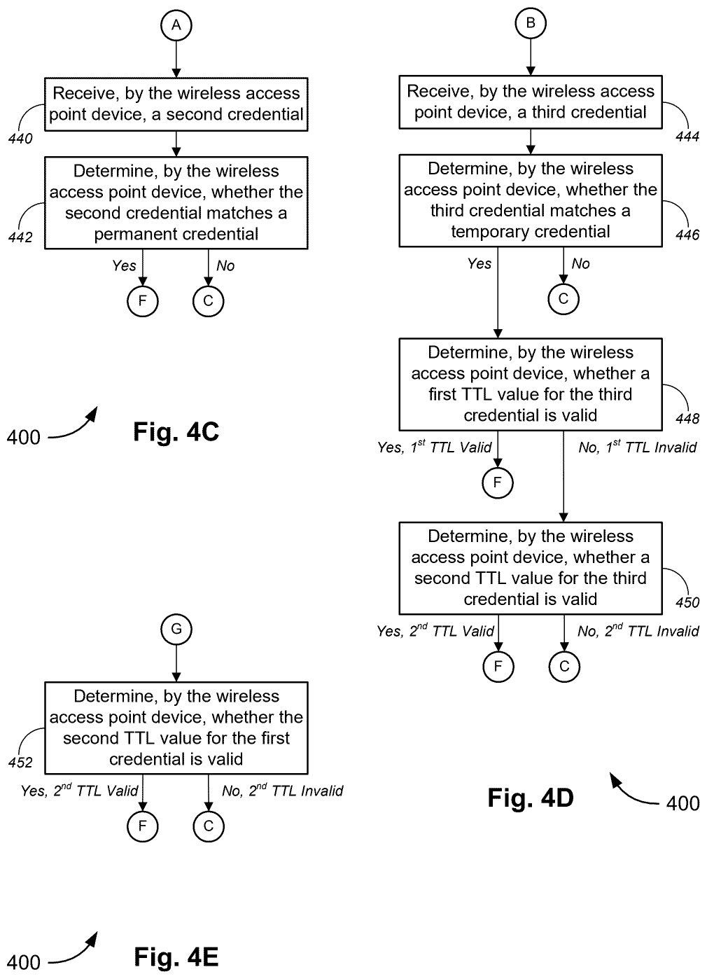

In other aspects, the wireless access point device 210 performs other methods for implementing credential management across multiple devices for wireless network access, such as method 300 of FIGS. 3A and 3B or method 400 of FIGS. 4A-4E, as described in detail below.

FIGS. 3A and 3B (collectively, “FIG. 3”) depict flow diagrams illustrating an example method 300 for implementing credential management across multiple devices for wireless network access, in accordance with various embodiments. Method 300 of FIG. 3A continues onto FIG. 3B following the circular marker denoted, “A,” and returns to FIG. 3A either following the circular marker denoted, “B,” or following the circular marker denoted, “C.”

In the non-limiting embodiment of FIG. 3A, method 300, at operation 305, includes receiving, by a wireless access point device and from a client device, an authentication request for connection to a wireless network. At operation 310, method 300 includes determining, by the wireless access point device, whether a credential has been associated with the client device. Based on a determination that the credential is a permanent credential, method 300 continues onto the process at operation 315. Based on a determination that the credential is a temporary credential, method 300 continues onto the process at operation 335. Based on a determination that the credential is a new credential, method 300 continues onto the process at operation 355 in FIG. 3B following the circular marker denoted, “A.” The client device and the wireless access point device are similar to corresponding client device and wireless access point device as described above with respect to FIGS. 1 and 2. The permanent credential and the temporary credential are similar to those as described above with respect to FIGS. 2A and 2B.

At operation 315, method 300 includes sending, by the wireless access point device and to the client device, a prompt to provide a credential; and, in response to receiving a first credential from the client device, determining, by the wireless access point device, whether the first credential matches a permanent credential (e.g., determining whether the first credential is valid) (at operation 320). Based on a determination that the first credential matches the permanent credential, and thus is determined to be valid, method 300 continues onto the process at operation 325. Based on a determination that the first credential fails to match the permanent credential, and thus is determined to be invalid, method 300 either continues onto the process at operation 330 or continues onto the process at operation 335 following the circular marker denoted, “B.” At operation 325, method 300 includes approving, by the wireless access point device, the authentication request for the client device, establishing, by the wireless access point device, a connection between the client device and the wireless network via the wireless access point device, and initiating, by the wireless access point device, a first session between the client device and the wireless network. Alternatively, at operation 330, method 300 includes denying the authentication request, which includes denying, by the wireless access point device, access to the wireless network by the client device.

At operation 335, method 300 includes sending, by the wireless access point device and to the client device, a prompt to provide a credential; and, in response to receiving a second credential from the client device, determining, by the wireless access point device, whether the second credential matches a temporary credential (e.g., determining whether the second credential is valid) (at operation 340). Based on a determination that the second credential matches the temporary credential, and thus is determined to be valid, method 300 continues onto the process at operation 345. Based on a determination that the second credential fails to match the temporary credential, and thus is determined to be invalid, method 300 continues onto the process at operation 330. At operation 345, method 300 includes, based on a determination that the second credential is valid, determining, by the wireless access point device, whether a first TTL value for the second credential is valid, wherein the valid second credential is unique to and associated with an identifier of the client device. When the first TTL value for the second credential is valid, method 300 continues onto the process at operation 325. When the first TTL value for the second credential is invalid, method 300 continues onto the process at operation 350, at which method 300 includes determining, by the wireless access point device, whether a second TTL value for the second credential is valid. When the second TTL value for the second credential is valid, method 300 continues onto the process at operation 325, at which the authentication request is approved, the connection between the client device and the wireless network is established, and the second session between the client device and the wireless network is initiated. When the second TTL value for the second credential is invalid, method 300 continues onto the process at operation 330, at which the authentication request is denied, resulting in access to the wireless network by the client device being denied. In examples, the temporary credentials may be automatically removed or caused to be deleted from the client device.

At operation 355 in FIG. 3B (following the circular marker denoted, “A,” in FIG. 3A), method 300 includes sending, by the wireless access point device and to an administrator device, a first authorization request for establishing a connection between the client device and the wireless network. Method 300 further includes, at operation 360, receiving, by the wireless access point device and from the administrator device, a first authorization response to the first authorization request. Based on the first authorization response indicating to deny access to the client device, method 300 continues onto the process at operation 330 following the circular marker denoted, “C.” Based on the first authorization response indicating to provide access to the client device, method 300 continues onto the process at operation 365.

At operation 365, method 300 includes generating and associating, by the wireless access point device, a third credential for and with the client device. Method 300 further includes, at operation 370, sending, by the wireless access point device, the third credential to the client device. Method 300 returns to the process at operation 335 in FIG. 3A following the circular marker denoted, “B.” Alternatively, at operation 375, method 300 includes setting, by the wireless access point device, a first TTL value for the third credential. In some instances, the first TTL value corresponds to a first time period, during which the third credential is valid, the first time period corresponding to a duration of a first session between the client device and the wireless access point device. At operation 380, method 300 includes setting, by the wireless access point device, a second TTL value for the third credential. In some cases, the second TTL value corresponds to a second time period, during which the third credential is valid, a start of the second time period following termination of the first time period. In some instances, setting the first TTL value and the second TTL value for the third credential are based on the first authorization response indicating to provide access to the client device. In some examples, the method 300 further includes, at operation 385, storing, in a data storage device, the third credential, the first TTL value, and the second TTL value, the third credential being associated with an identifier that is associated with the client device. Method 300 continues onto the process at operation 370, and subsequently returns to the process at operation 335 in FIG. 3A following the circular marker denoted, “B.”

FIGS. 4A-4E (collectively, “FIG. 4”) depict flow diagrams illustrating another example method 400 for implementing credential management across multiple devices for wireless network access, in accordance with various embodiments. Method 400 of FIG. 4A continues onto FIG. 4C following the circular marker denoted, “A,” and returns to FIG. 4A either following the circular marker denoted, “F,” or following the circular marker denoted, “C.” Method 400 of FIG. 4A either continues onto FIG. 4D following the circular marker denoted, “B,” and returns to FIG. 4A either following the circular marker denoted, “F,” or following the circular marker denoted, “C.” Method 400 of FIG. 4A continues onto FIG. 4B either following the circular marker denoted, “D,” or following the circular marker denoted, “E,” and returns to FIG. 4A either following the circular marker denoted, “F,” or following the circular marker denoted, “C.” Method 400 of FIG. 4A continues onto FIG. 4E following the circular marker denoted, “G,” and returns to FIG. 4A either following the circular marker denoted, “F,” or following the circular marker denoted, “C.”

In the non-limiting embodiment of FIG. 4A, method 400, at operation 402, includes receiving, by a wireless access point device and from a client device, a first authentication request for connection to a wireless network. At operation 404, method 400 includes sending, by the wireless access point device and to the client device, a prompt to either provide a credential or to request a new credential. In response to receiving a request for a new credential, method 400 continues onto the process at operation 406. In response to receiving a permanent credential, method 400 continues onto the process at operation 440 in FIG. 4C following the circular marker denoted, “A.” In response to receiving a temporary credential, method 400 continues onto the process at operation 444 in FIG. 4D following the circular marker denoted, “B.” The client device and the wireless access point device are similar to corresponding client device and wireless access point device as described above with respect to FIGS. 1 and 2. The permanent credential and the temporary credential are similar to those as described above with respect to FIGS. 2A and 2B.

At operation 406, method 400 includes sending, by the wireless access point device and to an administrator device, a first authorization request for establishing a connection between the client device and the wireless network. Method 400 further includes, at operation 408, receiving, by the wireless access point device and from the administrator device, a first authorization response to the first authorization request. Based on the first authorization response indicating to deny access to the client device, method 400 continues onto the process at operation 426 following the circular marker denoted, “C.” Based on the first authorization response indicating to provide access to the client device, method 400 continues onto the process at operation 410.

At operation 410, method 400 includes generating and associating, by the wireless access point device, a first credential for and with the client device. Method 400 further includes, at operation 412, setting, by the wireless access point device, a first TTL value for the first credential. In some instances, the first TTL value corresponds to a first time period, during which the first credential is valid, the first time period corresponding to a duration of a first session between the client device and the wireless access point device. In some examples, method 400 continues onto the process at operation 414. In other examples, method 400 continues onto the process at operation 418. At operation 414, method 400 includes setting, by the wireless access point device, a second TTL value for the first credential. In some cases, the second TTL value corresponds to a second time period, during which the first credential is valid, a start of the second time period following termination of the first time period. In some instances, setting the first TTL value and the second TTL value for the first credential are based on the first authorization response indicating to provide access to the client device. In some examples, the method 400 further includes, at operation 416, storing, in a data storage device, the first credential, the first TTL value, and the second TTL value, the first credential being associated with an identifier that is associated with the client device. Method 400 continues onto the process at operation 418. At operation 418, following the process at operation 412 or the process at operation 416, method 400 includes sending, by the wireless access point device, the first credential to the client device.

At operation 420, method 400 includes receiving, by the wireless access point device, a second authentication request from the client device, including the first credential. Method 400 further includes, at operation 422, determining, by the wireless access point device, whether the first TTL value for the first credential is valid. Based on a determination that the first TTL value is valid, method 400 continues onto the process at operation 424. Based on a determination that the first TTL value is invalid, method 400 either continues onto the process at operation 426 following the circular marker denoted, “C,” or continues onto the process at operation 452 in FIG. 4E following the circular marker denoted, “G.” At operation 452 in FIG. 4E (following the circular marker, denoted, “G”), method 400 includes determining, by the wireless access point device, whether the second TTL value for the first credential is valid. Based on a determination that the second TTL value is valid, method 400 continues onto the process at operation 424 in FIG. 4A following the circular marker denoted, “F.” Based on a determination that the second TTL value is invalid, method 400 continues onto the process at operation 426 following the circular marker denoted, “C.”

At operation 424, following the process at operation 422 or following the circular marker denoted, “F,” method 400 includes, when the first TTL value for the first credential is valid, approving, by the wireless access point device, the second authentication request for the client device, establishing, by the wireless access point device, a connection between the client device and the wireless network via the wireless access point device, and initiating, by the wireless access point device, a first session between the client device and the wireless network. Method 400 either continues onto the process at operation 428 following the circular marker denoted, “D,” or continues onto the process at operation 436 following the circular marker denoted, “E.” At operation 426, following the circular marker denoted, “C,” method 400 includes denying the second authentication request, which includes denying, by the wireless access point device, access to the wireless network by the client device.

At operation 428 in FIG. 4B (following the circular marker denoted, “D,” in FIG. 4A), method 400 includes, prior to expiration of the first time period corresponding to the first TTL value, sending, by the wireless access point device and to the administrator device, a second authorization request. Method 400 further includes, at operation 430, receiving, by the wireless access point device and from the administrator device, a second authorization response indicating whether to extend the first time period while the first session is continuing, by changing the first TTL value. Method 400 further includes, when the second authorization response indicates that the first time period should not be extended, causing, by the wireless access point device, the first session to be terminated upon the expiration of the first time period corresponding to the first TTL value (at operation 432). Alternatively, the method further includes, when the second authorization response indicates that the first time period should be extended, modifying, by the wireless access point device, the first TTL value based on the second authorization response to extend the first time period (at operation 434). Method 400 continues onto the process at operation 436.

At operation 436 (either following the process at operation 434 or following the circular marker denoted, “E,” in FIG. 4A), method 400 includes, based on a determination that the first session has terminated, receiving, by the wireless access point device, a third authentication request from the client device, including the first credential. Method 400 further includes determining, by the wireless access point device, whether the second TTL value for the first credential is valid (at operation 438). Based on a determination that the second TTL value is valid, method 400 continues onto the process at operation 424 in FIG. 4A following the circular marker denoted, “F.” In this case, method 400 further includes, when the second TTL value for the first credential is valid, approving, by the wireless access point device, the third authentication request for the client device, re-establishing, by the wireless access point device, a connection between the client device and the wireless network via the wireless access point device, and initiating a second session between the client device and the wireless network. Based on a determination that the second TTL value is invalid, method 400 continues onto the process at operation 426 in FIG. 4A following the circular marker denoted, “C.” In this case, method 400 further includes, denying the third authentication request, which includes denying, by the wireless access point device, access to the wireless network by the client device.

At operation 440 (following the circular marker denoted, “A,” in FIG. 4A), method 400 includes receiving, by the wireless access point device, a second credential. Method 400, at operation 442, includes determining, by the wireless access point device, whether the second credential matches a permanent credential. In examples, the permanent credential has a first TTL value that corresponds to one of a permanent first time period, an extended first time period, an automatically resetting first time period, or a periodically resetting first time period, or the like. Based on a determination that the second credential matches the permanent credential, method 400 continues onto the process at operation 424 in FIG. 4A following the circular marker denoted, “F.” In this case, method 400 further includes approving, by the wireless access point device, the first authentication request for the client device, establishing, by the wireless access point device, a connection between the client device and the wireless network via the wireless access point device, and initiating, by the wireless access point device, a first session between the client device and the wireless network. Based on a determination that the second credential fails to match the permanent credential, method 400 continues onto the process at operation 426 in FIG. 4A following the circular marker denoted, “C.” In this case, method 400 further includes, denying the first authentication request, which includes denying, by the wireless access point device, access to the wireless network by the client device.

At operation 444 (following the circular marker denoted, “B,” in FIG. 4A), method 400 includes receiving, by the wireless access point device, a third credential. Method 400, at operation 446, includes determining, by the wireless access point device, whether the third credential matches a temporary credential. In some cases, the temporary credential has a first TTL value that corresponds to a finite-duration first time period or limited-duration first time period. Based on a determination that the third credential fails to match the temporary credential, method 400 continues onto the process at operation 426 in FIG. 4A following the circular marker denoted, “C.” In this case, method 400 further includes, denying the first authentication request, which includes denying, by the wireless access point device, access to the wireless network by the client device. Based on a determination that the third credential matches the temporary credential, method 400 continues onto the process at operation 448. At operation 448, method 400 includes determining, by the wireless access point device, whether a first TTL value for the third credential is valid. Based on a determination that the first TTL value is valid, method 400 continues onto the process at operation 424 in FIG. 4A following the circular marker denoted, “F.” In this case, method 400 further includes approving, by the wireless access point device, the first authentication request for the client device, establishing, by the wireless access point device, a connection between the client device and the wireless network via the wireless access point device, and initiating, by the wireless access point device, a first session between the client device and the wireless network. Based on a determination that the first TTL value is invalid, method 400 continues onto the process at operation 450. At operation 450, method 400 includes determining, by the wireless access point device, whether a second TTL value for the third credential is valid. Based on a determination that the second TTL value is valid, method 400 continues onto the process at operation 424 in FIG. 4A following the circular marker denoted, “F.” In this case, method 400 further includes approving, by the wireless access point device, the first authentication request for the client device, re-establishing, by the wireless access point device, a connection between the client device and the wireless network via the wireless access point device, and initiating, by the wireless access point device, a second session between the client device and the wireless network. Based on a determination that the second TTL value is invalid, method 400 continues onto the process at operation 426 in FIG. 4A following the circular marker denoted, “C.” In this case, method 400 further includes, denying the first authentication request, which includes denying, by the wireless access point device, access to the wireless network by the client device.

While the techniques and procedures are depicted and/or described in a certain order for purposes of illustration, it should be appreciated that certain procedures may be reordered and/or omitted within the scope of various embodiments. Moreover, while the methods 300 and 400 illustrated by FIGS. 3 and 4, respectively, can be implemented by or with (and, in some cases, are described below with respect to) the systems, examples, or embodiments 100, 200A, and 200B of FIGS. 1, 2A, and 2B, respectively (or components thereof), such methods may also be implemented using any suitable hardware (or software) implementation. Similarly, while each of the systems, examples, or embodiments 100, 200A, and 200B of FIGS. 1, 2A, and 2B, respectively (or components thereof), can operate according to the methods 300 and 400 illustrated by FIGS. 3 and 4, respectively (e.g., by executing instructions embodied on a computer readable medium), the systems, examples, or embodiments 100, 200A, and 200B of FIGS. 1, 2A, and 2B can each also operate according to other modes of operation and/or perform other suitable procedures.

FIGS. 5A and 5B (collectively, “FIG. 5”) depict various example systems 500A and 500B illustrating various sets of example key data that are used by a wireless access point device when implementing access point or router-based rotation and exchange of data encryption/decryption keys, in accordance with various embodiments. In some embodiments, computing system 505 and client devices 530a-530n of FIG. 5 may be similar, if not identical, to the computing system 105a or 105b and client devices 130a-130n (and/or IoT device 125a-125m), respectively, of system 100 of FIG. 1, and the description of these components of system 100 of FIG. 1 are similarly applicable to the corresponding components of FIG. 5.

In FIG. 5, computing system 505 communicatively couples with at least one of one or more client devices 530a-530n (collectively, “client devices 530”), at least for purposes of exchanging encrypted keys that, when decrypted, may be used to encrypt data prior to sending to a network device via the computing system 505 or to decrypt encrypted data received from the network device via the computing system 505. Once a client device 530 has been authenticated and approved for connection to the wireless network, the computing system 505 provides a connection path(s) between the client device 530 and the wireless network for exchanging the encrypted keys and/or encrypted data. Computing system 505 includes Wi-Fi router 565 and database(s) 570. Each client device 530 has a MAC address associated with it. For each client device 530 that has been provided with access to the wireless network, keys for encrypting data for sending to the network device via the computing system 505 or for decrypting data received from the network device via the computing system 505 may be stored on database(s) 570 associated with a corresponding MAC address. In some cases, shared keys may also be stored on the database(s) 570, in some instances, associated with corresponding MAC address, while also being stored locally at corresponding client device (as shown, e.g., by shared keys 590a-590n each being stored on corresponding client devices 530a-530n). Where one or more TTL values are set for a particular key (whether encryption key, decryption key, or symmetric key (which is used for both encryption and decryption)), these values may also be stored on the database(s) 570 associated with the corresponding MAC address and corresponding credential(s). In some examples, the TTL values may include a first TTL value and a second TTL value. In examples, the first TTL value corresponds to a first time period, during which the corresponding key is valid for encrypting or decrypting data. In such examples, the second TTL value corresponds to a second time period, during which the corresponding key is valid for encrypting or decrypting data, a start of the second time period following termination of the first time period.

As shown in the non-limiting examples 500A and 500B of FIGS. 5A and 5B, respectively, key data 575 may include shared keys, encryption/decryption/symmetric keys, first TTL values, and second TTL values associated with corresponding MAC address that is associated with a client device among the one or more client devices 530a-530n. The first TTL values are listed as one of a permanent value for the first time period, an expiration date and time value(s) for the first time period that is years in the future, an expiration date and time value(s) for the first time period that has expired, or an expiration date and time value(s) for the first time period that is one or more minutes, one or more hours, one or more days, one or more weeks, or one or more months in the future, or the like. The second TTL values are listed as one of blank or not applicable, or an expiration date and time value(s) for the second time period (after the expiry of the first time period) that is minutes, hours, days, or weeks, or the like. In examples, the encryption/symmetric key corresponding to a client device 530 or its corresponding MAC address may be encrypted and the encrypted key 580a or 580b may be sent from the computing system 505 to the corresponding client device 530, the key 580a or 580b being subject to its corresponding TTL values. The encrypted key 580a corresponding to one of the client devices 530a-530n, once decrypted, can be used to encrypt data, and the encrypted data 585a may be sent to the computing system 505 or to the network device via the computing system 505, as shown in FIG. 5A. Alternatively, as shown in FIG. 5B, data may be encrypted and sent as encrypted data 585b to a requesting client device 530, which in some cases may request a key to decrypt the encrypted data. In response to such a request, the encrypted key 580b may be sent to the requesting client device 530.

Alternatively, although not shown in FIG. 5 but similar to the non-limiting example 200B of FIG. 2B, the first TTL values may be listed as one of an infinite or unlimited period for validity of the first time period, a time period value for validity of the first time period that is listed in years, or a time period value for validity of the first time period that is listed in minutes, one or more hours, one or more days, one or more weeks, or one or more months, or the like. The second TTL values may be listed as one of blank or not applicable, or a time period value for validity of the first time period that is listed in years, or a time period value for validity of the first time period that is listed in minutes, hours, days, or weeks, or the like. Although MAC addresses are used as identifiers associated with the client devices 530, other identifiers may also be used, each identifier including, but not limited to, one of a serial number of the client device, a combination of a model number and a device number associated with the client device, an IP address that is unique and associated with the client device, or the like.

In some aspects, with reference to non-limiting example 500A of FIG. 5A, from the perspective of a client device 530 among the one or more client devices 530a-530n, after being authenticated and after a connection has been established with the computing system 505, the client device 530 sends, to the computing system 505, a request for an encryption key. The client device 530 receives, from the computing system 505 and via the established connection, an encrypted encryption/symmetric key 580a, the encryption/symmetric key being generated based at least in part on an identifier (e.g., MAC address, IP address, etc.) of the client device 530, the encrypted encryption/symmetric key 580a being encrypted using a shared key 590. The client device 530 stores, in a local data storage device, the encrypted encryption/symmetric key 580a. The client device 530 decrypts the encrypted encryption/symmetric key 580a using the shared key 590. The client device 530 encrypts data (e.g., textual data, numerical data, alphanumerical data, image data, video data, game data, business data, health data, or personal data, etc.) using the encryption/symmetric key. After the data has been encrypted, the client device 530 sends the encrypted data to an external network or to a network device over the external network, via the computing system 505. In some cases, the client device 530 concurrently or sequentially sends, to the computing system 505, at least one of a time code or an identifier code associated with the encryption/symmetric key, the at least one of the time code or the identifier code being used by the computing system to identify the encryption/symmetric key being used by the client device 530.

From the perspective of the computing system 505, after authenticating the client device 530 and establishing a connection between the client device 530 and the computing system 505, the computing system 505 receives, from the client device 530, a request for an encryption key. After confirming authentication of the client device 530, the computing system 505 generates and associates an encryption/symmetric key based at least in part on an identifier (e.g., MAC address, IP address, etc.) of the client device 530. The computing system 505 encrypts the generated encryption/symmetric key using a shared key 590. The computing system 505 stores, in a data storage device 570 and in association with or in relation to the client device 530 and/or the identifier of the client device 530, either the generated encryption/symmetric key or the encrypted encryption/symmetric key. The computing system 505 sends the encrypted encryption/symmetric key 580a to the client device 530 via the established connection. After receiving, from the client device 530, data (e.g., textual data, numerical data, alphanumerical data, image data, video data, game data, business data, health data, or personal data, etc.) that has been encrypted using the encryption/symmetric key, the computing system 505 may send the encrypted data 585a to an external network or to a network device over the external network. In examples, the computing system includes one of a wireless access point device, a router, a server, a gateway device, or other network node.

In some other aspects, referring to non-limiting example 500B of FIG. 5B, from the perspective of client device 530 among the one or more client devices 530a-530n, after being authenticated and after a connection has been established with the computing system 505, the client device 530 sends, to the computing system 505, a request for first data. In some examples, the client device 530 receives, from the computing system 505, an encrypted first data. In other examples, the client device 530 concurrently or sequentially receives, from the computing system 505, the encrypted first data 585b and at least one of a time code or an identifier code associated with an encryption/symmetric key that was used to encrypt the encrypted first data and/or a corresponding decryption/symmetric key. In response to receiving encrypted first data 585b, the client device 530 determines whether a locally stored decryption/symmetric key is capable of decrypting the encrypted first data (e.g., textual data, numerical data, alphanumerical data, image data, video data, game data, business data, health data, or personal data, etc.). Based on a determination that the locally stored first decryption/symmetric key is capable of decrypting the encrypted first data, the client device 530 decrypts the encrypted first data using the first decryption/symmetric key, allowing the first data to be viewed, used, or otherwise consumed. Based on a determination that the locally stored first decryption/symmetric key is incapable of decrypting the encrypted first data, the client device 530 sends, to the computing system 505, a request for a decryption key that either corresponds to the encrypted first data and/or is capable of decrypting the encrypted first data. The client device 530 receives, from the computing system 505 and via the established connection, an encrypted second decryption/symmetric key 580b, the second decryption/symmetric key being generated based at least in part on an identifier (e.g., MAC address, IP address, etc.) of the client device, the encrypted second decryption/symmetric key 580b being encrypted using a shared key 590. The client device 530 stores, in a local data storage device, the encrypted second decryption/symmetric key 580b. The client device 530 decrypts the encrypted second decryption/symmetric key 580b using the shared key 590. The client device 530 decrypts the first data using the second decryption/symmetric key.

From the perspective of the computing system 505, after authenticating the client device 530 and establishing a connection between the client device 530 and the computing system 505, the computing system 505 receives, from the client device 530, a request for first data. After confirming authentication of the client device 530, the computing system 505 retrieves the first data from one of a local cache, a local data storage system, a server accessible over a network, a network node accessible over the network, or a cloud storage system, and/or the like. The computing system 505 generates an encryption key and a corresponding decryption key or a symmetric key, based at least in part on an identifier (e.g., MAC address, IP address, etc.) of the client device 530, and encrypts the retrieved first data using the encryption key or symmetric key. The computing system 505 sends, to the client device 530, the encrypted first data 585b in response to the request. In examples, the computing system 505 concurrently or sequentially sends, to the client device 530, the encrypted first data 585b and at least one of a time code or an identifier code associated with the encryption/symmetric key that was used to encrypt the encrypted first data and/or the corresponding decryption/symmetric key. In response to receiving, from the client device 530, a request for a decryption key that either corresponds to the encrypted first data and/or is capable of decrypting the encrypted first data, the computing system 505 encrypts the decryption/symmetric key using a shared key 590, and sends, to the client device 530 and via the established connection, the encrypted decryption/symmetric key 580b. This enables the client device 530 to decrypt the encrypted first data 585b using the decryption/symmetric key, after decrypting the encrypted decryption/symmetric key 580b using the shared key 590. The decrypted first data can subsequently be viewed, used, or otherwise consumed by the client device 530.

In other aspects, the computing system 505 performs other methods for implementing access point or router-based rotation and exchange of data encryption/decryption keys, such as methods 600A and 600B of FIGS. 6A and 6B, respectively, as described in detail below.

FIGS. 6A and 6B (collectively, “FIG. 6”) depict flow diagrams illustrating various example methods 600A and 600B for implementing access point or router-based rotation and exchange of data encryption/decryption keys, in accordance with various embodiments.

In the non-limiting embodiment of FIG. 6A, method 600A, at operation 605, includes receiving, by a computing system and from a client device, a request for a key. At operation 610, method 600A includes confirming, by the computing system, authentication of the client device. In examples, confirming authentication of the client device includes authenticating, by the computing system, the client device (at operation 610a); and, after authenticating the client device, establishing, by the computing system, the connection between the client device and the computing system (at operation 610b). In some examples, authenticating the client device (at operation 610a) and establishing the connection (at operation 610b) may be performed based on method 300 or 400 of FIG. 3 or 4, respectively. For instance, where the computing system includes a wireless access point device, after authenticating the client device and prior to establishing the connection, the wireless access point device may perform the following: generating and associating a first credential for and with the client device; setting a first TTL value for the first credential, wherein the first TTL value corresponds to a first time period, during which the first credential is valid, the first time period corresponding to a duration of a first session between the client device and the wireless access point device; setting a second TTL value for the first credential, wherein the second TTL value corresponds to a second time period, during which the first credential is valid, a start of the second time period following termination of the first time period; setting a second TTL value for the first credential, wherein the second TTL value corresponds to a second time period, during which the first credential is valid, a start of the second time period following termination of the first time period; and sending, by the wireless access point device, the first credential to the client device. In some examples, establishing the connection is performed after receiving the first credential from the client device, while one of the first TTL value or the second TTL value is valid. In examples, the computing system includes one of a wireless access point device, a router, a server, a gateway device, or other network node, and/or the like.

Method 600A further includes, at operation 615, generating, by the computing system, a first key based at least in part on an identifier of the client device. In some instances, the first key is a temporary key. In some examples, the identifier of the client device includes one of a MAC address, a serial number, a combination of model number and device number, or an IP address, and/or the like. At operation 620, method 600A includes encrypting, by the computing system, the first key using a shared key, the shared key including a key or key-pair that is shared between the computing system and the client device. Method 600A further includes storing, by the computing system, one of the first key or the encrypted first key in a secure key storage system of a data storage device, in association with or in relation to the client device and/or the identifier of the client device (at operation 625). In some cases, the data storage device is one of a local data storage device, a remote data storage device, or a cloud storage device, and/or the like. At operation 630, method 600A includes sending, by the computing system, the encrypted first key via a connection that is established between the client device and the computing system. In some examples, the encrypted first key, after being decrypted by the shared key, is usable by the client device either to encrypt first data for sending over an external network via the computing system or to decrypt second data that is received over the external network via the computing system. In examples, the first data and the second data each includes at least one of textual data, numerical data, alphanumerical data, image data, video data, game data, business data, health data, or personal data, and/or the like.

Method 600A further includes, at operation 635, in response to a determination or an indication that the client device has either lost connection to the computing system or lost power, causing, by the computing system, the first key to be invalidated or to expire. Alternatively or additionally, method 600A further includes, at operation 640, after receiving, from the client device, the first data that has been encrypted using the first key, sending, by the computing system, the encrypted first data to one of the external network or a first network device over the external network, wherein the first key includes one of an encryption key or a symmetric key. Alternatively or additionally, method 600A further includes, at operation 645, after receiving, from one of the external network or a second network device over the external network, the second data, encrypting, by the computing system, the second data using a second key, and sending, by the computing system, the encrypted second data to the client device, wherein the first key is used to decrypt the encrypted second data, wherein the first key includes one of a decryption key or the symmetric key.

Referring to the non-limiting embodiment of FIG. 6B, method 600B, at operation 650, includes receiving, by a computing system and from a client device, a request for first data. Similar to operations 610, 610a, and 610b, method 600B further includes confirming, by the computing system, authentication of the client device (at operation 655); authenticating, by the computing system, the client device (at operation 655a); and, after authenticating the client device, establishing, by the computing system, the connection between the client device and the computing system (at operation 655b); respectively. In examples, the computing system includes one of a wireless access point device, a router, a server, a gateway device, or other network node, and/or the like.

At operation 660, method 600B includes, after confirming authentication of the client device, retrieving, by the computing system, the first data from a data source. In some examples, the data source includes one of a local cache, a local data storage system, a server accessible over a network, a network node accessible over the network, or a cloud storage system, and/or the like. Method 600B further includes, at operation 665, generating, by the computing system, a first key, based at least in part on an identifier of the client device. In some instances, the first key is a temporary key. Method 600B further includes encrypting, by the computing system, the retrieved first data using the first key (at operation 670). In some cases, method 600B, at operation 675, includes storing, by the computing system, one of the first key or the encrypted first key in a secure key storage system of a data storage device, in association with or in relation to the client device and/or the identifier of the client device. In some instances, the data storage device is one of a local data storage device, a remote data storage device, or a cloud storage device, and/or the like. At operation 680, method 600B includes sending, by the computing system and to the client device and via a connection that has been established between the client device and the computing system, the encrypted first data in response to the request.

Method 600B further includes, at operation 685, sending, by the computing system and to the client device, at least one of a time code or an identifier code associated with one or more of the first key or a corresponding second key, concurrent or in sequence with sending the encrypted first data, the first key having been used to encrypt the encrypted first data. Alternatively or additionally, method 600B further includes, in response to receiving, from the client device, a request for a decryption key that either corresponds to the encrypted first data or is capable of decrypting the encrypted first data, encrypt the corresponding second key using a shared key (at operation 690); and send, to the client device and via the established connection, the encrypted second key (at operation 695). In some examples, the first key includes one of an encryption key or a symmetric key, while the second key includes one of a decryption key corresponding to the encryption key or the symmetric key.

In some examples, in response to a determination or an indication that the client device has either lost connection to the computing system or lost power, the computing system may cause the first key to be invalidated or to expire.

While the techniques and procedures are depicted and/or described in a certain order for purposes of illustration, it should be appreciated that certain procedures may be reordered and/or omitted within the scope of various embodiments. Moreover, while the method 600A or 600B illustrated by FIG. 6A or 6B can be implemented by or with (and, in some cases, are described below with respect to) the systems, examples, or embodiments 100, 500A, and 500B of FIGS. 1, 5A, and 5B, respectively (or components thereof), such methods may also be implemented using any suitable hardware (or software) implementation. Similarly, while each of the systems, examples, or embodiments 100, 500A, and 500B of FIGS. 1, 5A, and 5B, respectively (or components thereof), can operate according to the method 600A or 600B illustrated by FIG. 6A or 6B (e.g., by executing instructions embodied on a computer readable medium), the systems, examples, or embodiments 100, 500A, and 500B of FIGS. 1, 5A, and 5B can each also operate according to other modes of operation and/or perform other suitable procedures.

### Exemplary System and Hardware Implementation

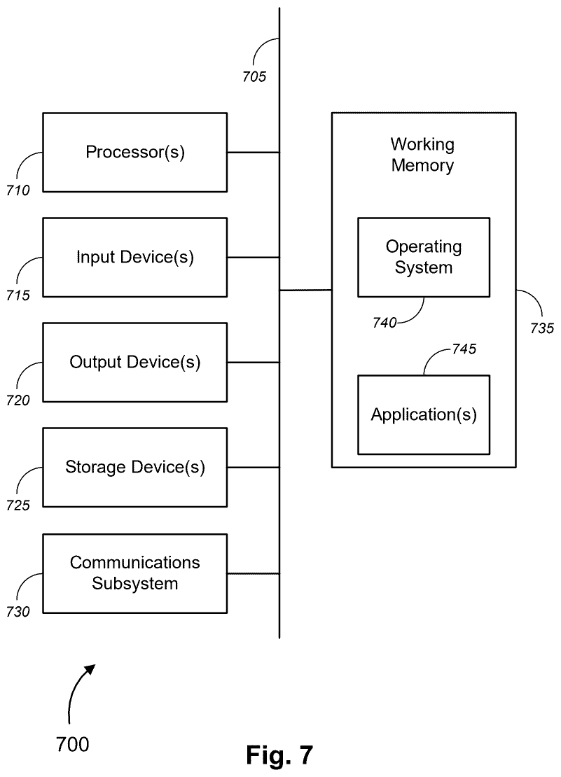

FIG. 7 is a block diagram illustrating an exemplary computer or system hardware architecture, in accordance with various embodiments. FIG. 7 provides a schematic illustration of one embodiment of a computer system 700 of the service provider system hardware that can perform the methods provided by various other embodiments, as described herein, and/or can perform the functions of computer or hardware system (i.e., computing systems 105a, 105b, and/or 505, wireless access point devices 110 and 210, IoT devices 125a-125m, client devices 130a-130n, 230a-230n, and/or 530a-530n, and Wi-Fi routers 265 and/or 565, etc.), as described above. It should be noted that FIG. 7 is meant only to provide a generalized illustration of various components, of which one or more (or none) of each may be utilized as appropriate. FIG. 7, therefore, broadly illustrates how individual system elements may be implemented in a relatively separated or relatively more integrated manner.

The computer or hardware system 700—which might represent an embodiment of the computer or hardware system (i.e., computing systems 105a, 105b, and/or 505, wireless access point devices 110 and 210, IoT devices 125a-125m, client devices 130a-130n, 230a-230n, and/or 530a-530n, and Wi-Fi routers 265 and/or 565, etc.), described above with respect to FIGS. 1-6—is shown including hardware elements that can be electrically coupled via a bus 705 (or may otherwise be in communication, as appropriate). The hardware elements may include one or more processors 710, including, without limitation, one or more general-purpose processors and/or one or more special-purpose processors (such as microprocessors, digital signal processing chips, graphics acceleration processors, and/or the like); one or more input devices 715, which can include, without limitation, a mouse, a keyboard, and/or the like; and one or more output devices 720, which can include, without limitation, a display device, a printer, and/or the like.

The computer or hardware system 700 may further include (and/or be in communication with) one or more storage devices 725, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 700 might also include a communications subsystem 730, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 730 may permit data to be exchanged with a network (such as the network described below, to name one example), with other computer or hardware systems, and/or with any other devices described herein. In many embodiments, the computer or hardware system 700 will further include a working memory 735, which can include a RAM or ROM device, as described above.

The computer or hardware system 700 also may include software elements, shown as being currently located within the working memory 735, including an operating system 740, device drivers, executable libraries, and/or other code, such as one or more application programs 745, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 725 described above. In some cases, the storage medium might be incorporated within a computer system, such as the system 700. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 700 and/or might take the form of source and/or installable code, which, upon compilation and/or installation on the computer or hardware system 700 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 700) to perform methods in accordance with various embodiments of the invention. According to a set of embodiments, some or all of the procedures of such methods are performed by the computer or hardware system 700 in response to processor 710 executing one or more sequences of one or more instructions (which might be incorporated into the operating system 740 and/or other code, such as an application program 745) contained in the working memory 735. Such instructions may be read into the working memory 735 from another computer readable medium, such as one or more of the storage device(s) 725. Merely by way of example, execution of the sequences of instructions contained in the working memory 735 might cause the processor(s) 710 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 700, various computer readable media might be involved in providing instructions/code to processor(s) 710 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 725. Volatile media includes, without limitation, dynamic memory, such as the working memory 735. In some alternative embodiments, a computer readable medium may take the form of transmission media, which includes, without limitation, coaxial cables, copper wire, and fiber optics, including the wires that include the bus 705, as well as the various components of the communication subsystem 730 (and/or the media by which the communications subsystem 730 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 700. These signals, which might be in the form of electromagnetic signals, acoustic signals, optical signals, and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 705 retrieves and executes the instructions. The instructions received by the working memory 735 may optionally be stored on a storage device 725 either before or after execution by the processor(s) 710.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for case of description and to illustrate exemplary aspects of those embodiments, the various components and/or features described herein with respect to a particular embodiment can be substituted, added and/or subtracted from among other described embodiments, unless the context dictates otherwise. Consequently. although several exemplary embodiments are described above, it will be appreciated that the invention is intended to cover all modifications and equivalents within the scope of the following claims.

What is claimed is:

1. A method, comprising:
receiving, by a computing system and from a client device, a request for a key;
after confirming authentication of the client device, generating, by the computing system, a first key based at least in part on an identifier of the client device, wherein the first key is a temporary key;
encrypting, by the computing system, the first key using a shared key, the shared key including a key or key-pair that is shared between the computing system and the client device; and
sending, by the computing system, the encrypted first key via a connection that is established between the client device and the computing system, wherein the encrypted first key, after being decrypted by the shared key, is usable by the client device either to encrypt first data for sending over an external network via the computing system or to decrypt second data that is received over the external network via the computing system.

2. The method of claim 1, wherein the computing system includes one of a wireless access point device, a router, a server, a gateway device, or other network node.

3. The method of claim 1, wherein the identifier of the client device includes one of a media access control (“MAC”) address, a serial number, a combination of model number and device number, or an Internet protocol (“IP”) address.

4. The method of claim 1, wherein the first data and the second data each includes at least one of textual data, numerical data, alphanumerical data, image data, video data, game data, business data, health data, or personal data.

5. The method of claim 1, wherein confirming authentication of the client device comprises:
authenticating, by the computing system, the client device; and
after authenticating the client device, establishing, by the computing system, the connection between the client device and the computing system.

6. The method of claim 5, wherein the computing system includes a wireless access point device, wherein the method further comprises, after authenticating the client device and prior to establishing the connection:
generating and associating, by the wireless access point device, a first credential for and with the client device;
setting, by the wireless access point device, a first time-to-live (“TTL”) value for the first credential, wherein the first TTL value corresponds to a first time period, during which the first credential is valid, the first time period corresponding to a duration of a first session between the client device and the wireless access point device;
setting, by the wireless access point device, a second TTL value for the first credential, wherein the second TTL value corresponds to a second time period, during which the first credential is valid, a start of the second time period following termination of the first time period; and
sending, by the wireless access point device, the first credential to the client device;
wherein establishing the connection is performed after receiving the first credential from the client device, while one of the first TTL value or the second TTL value is valid.

7. The method of claim 1, further comprising:
storing, by the computing system, one of the first key or the encrypted first key in a secure key storage system of a data storage device, in association with or in relation to the client device and/or the identifier of the client device, wherein the data storage device is one of a local data storage device, a remote data storage device, or a cloud storage device.

8. The method of claim 1, further comprising:
in response to a determination or an indication that the client device has either lost connection to the computing system or lost power, causing, by the computing system, the first key to be invalidated or to expire.

9. The method of claim 1, further comprising one of:
after receiving, from the client device, the first data that has been encrypted using the first key, sending, by the computing system, the encrypted first data to one of the external network or a first network device over the external network, wherein the first key includes one of an encryption key or a symmetric key; or
after receiving, from one of the external network or a second network device over the external network, the second data, encrypting, by the computing system, the second data using a second key, and sending, by the computing system, the encrypted second data to the client device, wherein the first key is used to decrypt the encrypted second data, wherein the first key includes one of a decryption key or the symmetric key.

10. A system, comprising:
a computing system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
receive, from a client device, a request for first data;
after confirming authentication of the client device, retrieve the first data from a data source;
generate a first key, based at least in part on an identifier of the client device;
encrypt the retrieved first data using the first key; and
send, to the client device and via a connection that has been established between the client device and the computing system, the encrypted first data in response to the request.

11. The system of claim 10, wherein the computing system includes one of a wireless access point device, a router, a server, a gateway device, or other network node.

12. The system of claim 10, wherein the data source includes one of a local cache, a local data storage system, a server accessible over a network, a network node accessible over the network, or a cloud storage system.

13. The system of claim 10, wherein the first set of instructions, when executed by the at least one first processor, further causes the computing system to:
send, to the client device, at least one of a time code or an identifier code associated with one or more of the first key or a corresponding second key, concurrent or in sequence with sending the encrypted first data, the first key having been used to encrypt the encrypted first data.

14. The system of claim 13, wherein the first key includes one of an encryption key or a symmetric key, wherein the second key includes one of a decryption key corresponding to the encryption key or the symmetric key.

15. The system of claim 13, wherein the first set of instructions, when executed by the at least one first processor, further causes the computing system to:
in response to receiving, from the client device, a request for a decryption key that either corresponds to the encrypted first data or is capable of decrypting the encrypted first data, encrypt the corresponding second key using a shared key; and
send, to the client device and via the established connection, the encrypted second key.

16. A method, comprising:
receiving, by a computing system and from a client device, a request for a key;
after confirming authentication of the client device, generating and associating, by the computing system, a first key based at least in part on an identifier of the client device, wherein the first key includes one of an encryption key or a symmetric key, wherein the first key is a temporary key;
encrypting, by the computing system, the first key using a shared key, the shared key including a key or key-pair that is shared between the computing system and the client device;
sending, by the computing system, the encrypted first key via a connection that is established between the client device and the computing system; and
after receiving, from the client device, first data that has been encrypted using the first key, sending, by the computing system, the encrypted first data to one of the external network or a first network device over the external network.

17. The method of claim 16, wherein the identifier of the client device includes one of a media access control (“MAC”) address, a serial number, a combination of model number and device number, or an Internet protocol (“IP”) address.

18. The method of claim 16, wherein the first data and the second data each includes at least one of textual data, numerical data, alphanumerical data, image data, video data, game data, business data, health data, or personal data.

19. The method of claim 16, further comprising:
storing, by the computing system, one of the first key or the encrypted first key in a secure key storage system of a data storage device, in association with or in relation to the client device and/or the identifier of the client device, wherein the data storage device is one of a local data storage device, a remote data storage device, or a cloud storage device.

20. The method of claim 16, further comprising:
in response to a determination or an indication that the client device has either lost connection to the computing system or lost power, causing, by the computing system, the first key to be invalidated or to expire.
